(19) United States
(12) Patent Application Publication
(10) Pub. No.: US 2018/0194276 A1
(43) Pub. Date: Jul. 12, 2018

(54) ILLUMINATED TIRES AND WHEEL ASSAMBLY

(71) Applicant: Donaldo Rex Mitogo, Providence, RI (US)

(72) Inventor: Donaldo Rex Mitogo, Providence, RI (US)

(21) Appl. No.: 15/399,964

(22) Filed: Jan. 6, 2017

(51) Int. Cl. B60Q 1/32; B60B 3/04; G08B 5/22; G09F 9/33; G09F 21/04

(52) U.S. Cl. CPC B60Q 1/326; B60B 3/04; B60B 7/00; G09F 9/33; G09F 21/045; G08B 5/22

(57) ABSTRACT

The Illuminated Tires and Wheel Assembly, is an advanced car tire that displays contrasting colors within the tire to yield caution to other drivers and pedestrians. The sole purpose of this tire is to reduce and eliminate road accidents due to poor driving, broken taillights, and miscommunication between drivers, pedestrians, and everything in its surroundings. The mission of the Illuminated Tires and Wheel Assembly is but not limited to ease the communication between drivers and pedestrians in a novel manner. Pedestrians ought to know that when this advanced car tire is illuminating in color “Blue” it means the car ignition is on, color “Red” means the car is in motion and finally, when the entire tire is glowing in color “Green” simply means that the breaks have been applied.

### BACKGROUND OF THE INVENTION

### Field of Invention

The present invention relates to a combination of a car Tire with Rims and Lights to display caution in a novel manner or in other words, Tire and wheel assembly that is illuminated to indicate vehicle motion.

### Description of Related Art

Motor vehicles are well-appointed with numerous safety equipment. The genesis of theses safety equipment is to communicate with other drivers such as turn signals; brake lights and even headlights provide an indication of vehicle intention for other drivers. Brake lights normally are located at the back of the vehicle providing an indication of the vehicle coming to a stop or the brakes have been applied. These rear and headlights communicate with other drivers cautioning of the driver's activities. However, it shall be advantageous to foster other forms of illuminated communication with the other driver and the people at the surroundings. Such as an indication of wheel rotation to provide a further safety feature.

### Description of the Actual Invented Tire

Although breaks lights at the rear of a vehicle are common indicators of stopping, drivers are unable to gauge their distance to a vehicle with broken or burnt out tail lights in dimly lit areas. In addition to that, pedestrians cannot predict the actions or the intention of maneuver the driver is preparing on taken due to broken brake lights and the miss-use of turn signals. My ILLUMINATED TIRE called “Rex M6 Royal”, it is a combination of lights embedded into the tire like a “traffic light” to display caution to other drivers and pedestrians in a novel manner. This cutting-edge advance electrical engineering technology product is comprised of Tires with Lights and Rims. Easy to use, simply install the product onto any vehicle; upon starting the car the lights on the tires will illuminate in “light blue”, when the gas pedal is pressed in the drive position the lights on the tires will automatically transition to the color “red”, and upon applying the brakes, the color will change to “light green”.

### DRAWING DESCRIPTION

### Brief Description of the Drawings

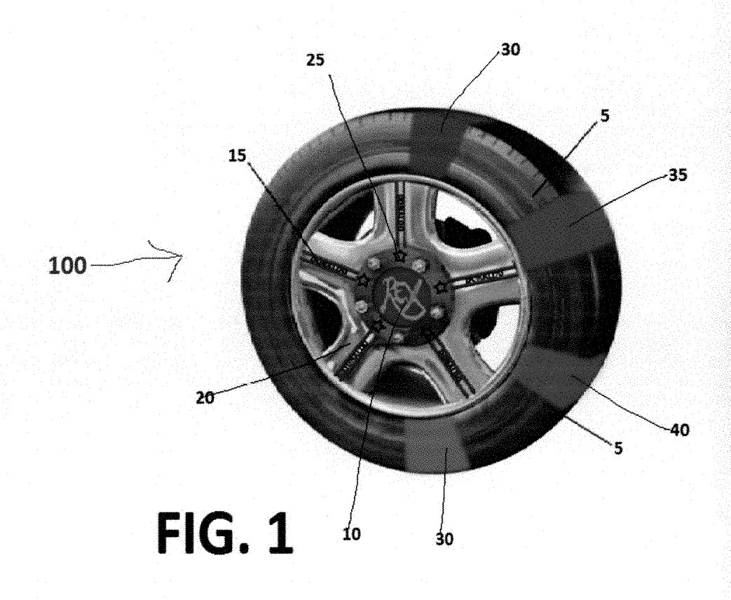

FIG. 1 depicts a tire and wheel assembly that includes illumination associated with vehicle motion. The entire tire glow “Blue” when the car in on. The entire tire glow “Red” when the car is in motion. The entire tire glow “Green” when the brakes are applied. Blue being the tire base color.

### UNIQUE FEATURES OF THE INVENTION

“Rex M6 Royal” is the only product of its kind that features all season and weather resistant tires, shiny chrome Rims with “REX” logos in the center to afford the user durable performance and a customized appearance. The “Rex M6 Royal” is uniquely designed to be powered by the vehicle's battery for consistence utilization and manufactured in a variety of sizes to suit any vehicle. Further illumination alerts other drivers that the vehicle is coming to a stop when the tires are illuminating in green, pedestrians will know that nobody shall cross in front nor rear of the vehicle when the tires are illuminating in red because it is obvious that the vehicle is in motion. These set of advanced safety features is what set this innovated tires apart from the rest of safety products out there, because this tires will promote safety as the traffic lights hang on the roads changing colors, the same way these tires promote safety with lights embedded in them to change colors, in which every single color means something. Every color sends out a significant caution and indicate the maneuver of the driver by contrasting colors.

### Details of FIG. 1

FIG. 1, presents a drawing of the illuminated tire. The tire features all season and weather resistant tires (5), shiny Rims (20) to ease the contrasting colors with “REX” (10) logos in the center printed in gold to afford the user durable performance and customized appearance. Skinny hot Red lines within the word “DONALDO” (15) written in between the two skinny hot Red lines and the entire circle being red to promote unique customize appearance. Stars (25) around the red circle. Blue color (30) when the car ignition is on Transitioning into the color Red (35) when the car is in motion. Upon applying the breaks, when entire tire will illuminate in color Green (40).

Lighting and contrast to determine vehicle motion and activity. The prompt invention has been revealed and labeled in what it considers to be the most practical and preferred embodiments. It is known, however, that departures may be made there from within the scope of the invention and that obvious modifications will occur to a person skilled in the art.

What is claimed is:

1. A method of vehicle motion indication including:
1. Installing a set of color changing tires onto a vehicle and including a chrome rim for each tire; where the each chrome rim includes a red color center and red lines extending from the center;
2. Determine a sequence of color change for the tires, where the sequence of color change toggles through two colors or more; Designating colors for the vehicle ignition, vehicle brakes applied, vehicle in movement, and a base color for the vehicle ignition/parked;
3. Installing a set of color changing tires onto a vehicle with “REX” logos in the center and “DONALDO” written between the red lines and Stars symbols placed around the chrome.
